(19) United States
(12) Patent Application Publication
(10) Pub. No.: US 2018/0039107 A1
(43) Pub. Date: Feb. 8, 2018

(54) DISPLAY DEVICE

(71) Applicant: SHARP KABUSHIKI KAISHA, Sakai City, Osaka (JP)

(72) Inventors: TAKASHI SASAKI, Sakai City (JP); KOHJI NAGASAKA, Sakai City (JP); KAZUMASA HATA, Sakai City (JP)

(21) Appl. No.: 15/555,793

(22) PCT Filed: Feb. 26, 2016
(86) PCT No.: PCT/JP2016/055801

§ 371 Date: Sep. 5, 2017

(30) Foreign Application Priority Data
Mar. 5, 2015 (JP) 2015-043481

(51) Int. Cl. G02F 1/13; G09G 3/00; H04N 5/57; G09G 3/36

(52) U.S. Cl. CPC G02F 1/1309; G09G 3/3607; G09G 3/006; H04N 5/57; G09G 2320/0233

(57) ABSTRACT

Provided is a display device allowing a plurality of pieces of correction data for correcting uneven display which occurs on a display panel to be respectively written to a plurality of memory devices without error. In the case where correction. data writing tools (80a, 80b) are connected to connectors (24a, 24b), even if the tools are mistakenly connected to the wrong connectors, a PC (90) determines whether a SEL signal provided by each connector (24a, 24b) is at H- or L-level. As a result, the PC (90) can identify the connectors (24a, 24b) to which the correction data writing tools (80a, 80b) are connected, and write correction data that should be written, to respective memory devices (50a, 50b) without error.

### TECHNICAL FIELD

The present invention relates to display devices such as liquid crystal display devices, particularly to a display device allowing correction data for correcting uneven display to be properly written even if there is some work error at the time of writing.

### BACKGROUND ART

Uneven display, such as brightness inconsistency and color irregularities, which might occur when an image is displayed on a liquid crystal panel of a liquid crystal display device, causes a reduction in image display quality, and therefore, it is desirable to avert uneven display. One type of such uneven display is common among liquid. crystal display devices and is attributed to design, e.g., the arrangement of light sources in a backlight unit, and another type is inherent in each liquid crystal display device and is attributed to variations in the process of producing liquid crystal panels. Accordingly, there have been improvements to design and the production process for the purpose of inhibiting the occurrence of uneven display, but it is difficult to eliminate uneven display simply by such improvements to design and the production process.

Therefore, to eliminate uneven display, a display device disclosed in Patent Document 1 includes a memory device with correction data stored therein, and when image data is externally inputted, the correction data is read from the memory device and used to correct the image data, with the result that an image is displayed on the basis of the corrected image data. Thus, the display device can display an image free from uneven display.

### CITATION LIST

### Patent Document

Patent Document Japanese Laid-Open Patent Publication No. 11-352920

### SUMMARY OF THE INVENTION

### Problems to be Solved by the Invention

As the size and the resolution of the liquid crystal panel increase, the amount of data required for image display increases, creating difficulty in processing all of the required data by only one timing controller. Accordingly, a plurality of timing controllers are provided so as share the data processing among, the timing controllers. In this case, one memory device having stored therein correction data for correcting uneven display needs to be provided for each timing controller.

However, for example, in the case where two timing controllers are provided, a work error might occur during the process of writing correction data to two memory devices provided corresponding to the respective timing controllers, with the result that correction data to be written to one memory device is written to the other memory device, and vice versa.

To eliminate such a work error, it is conceivable that connectors to be connected with correction data writing tools for use in writing correction data are provided in different shapes so as to be dedicated for exclusive use with respective memory devices. In this case, the worker can select a connector electrically connected to a memory device to which correction data should be written, based on the shape of the connector, and connect a correction data writing tool to the connector, resulting in a significant reduction in the work error of mistakenly writing correction data to another memory device. However, preparing the connectors in different shapes for the respective memory devices results in problems with increased connector production cost and additional trouble of management. Accordingly, it is preferable that all connectors for use in writing different correction data to respective memory devices be provided in the same shape.

Therefore, an objective of the present invention is to provide a display device allowing a plurality of pieces of correction data for correcting uneven display which occurs on a display panel to be written to respective memory devices without error.

### Means for Solving the Problems

A first aspect of the present invention is directed to a display device, the device including:
a display panel;
a plurality of driver circuits configured to drive the display panel;
a plurality of timing controllers configured to generate image data and timing control signals for controlling the driver circuits, on the basis of an externally provided image signal, and provide the image data and the timing control signals to the driver circuits, whereby the control of a display screen of the display panel is shared by the timing controllers;
a plurality of first data storage portions configured to store correction data for use in correcting the image data to eliminate uneven display occurring at the time of image display on the display panel, the first data storage portions being connected to the timing controllers; and
a plurality of connectors electrically connected to the first data storage portions and the timing controllers, wherein,
the connectors are connected to a plurality of correction data writing tools capable of writing the correction data, whereby the correction data writing tools obtain distinguishing information for identifying the first data storage portions, via the connectors, and write the correction data that are to be written, to the respective first data storage portions on the basis of the distinguishing information, and
the timing controllers correct the image data using the correction data being read from the first data storage portions.

A second aspect of the present invention provides the display device according to the first aspect of the present invention, wherein,
the distinguishing information is a combination of different voltage levels assigned to the respective first data storage portions,
the connectors include terminals for outputting the combination of assigned voltage levels, and
the correction data writing tools connected to the connectors identify the connected connectors on the basis of the combination of voltage levels outputted from the terminals, and write the correction data to the first data storage portions via the connectors.

A third aspect of the present invention provides the display device according to the first aspect of the present invention, wherein,
the distinguishing information is distinguishing data consisting of a plurality of bits written in the first data storage portions, and
the correction data writing tools connected to the connectors identify the connectors electrically connected to the first data storage portions, on the basis of the distinguishing data being read from the first data storage portions, and write the correction data to the first data storage portions via the connectors.

A fourth aspect of the present invention provides the display device according to the first aspect of the present invention, wherein,
the distinguishing information is distinguishing data consisting of a plurality of bits written in the first data storage portions,
the display device further includes a plurality of second data storage portions configured to store the distinguishing data externally provided along with the image signal, the second data storage portions being electrically connected to the timing controllers,
the timing controllers include third data storage portions, access the second data storage portions at predetermined times to read the image signal including the stored distinguishing data, and write at least the distinguishing data to the third data storage portions, and
when the distinguishing data is written to the third data storage portion, the correction data writing tool reads the distinguishing data written in the third data storage portion of the timing controller via the connector, identifies the first data storage portion electrically connected to the connector on the basis of the distinguishing data, and writes the correction data to the first data storage portion via the connector.

A fifth aspect of the present invention provides the display device according to the fourth aspect of the present invention, further including a control board and source boards provided close to the display panel and having components of the display device mounted thereon, wherein,
the driver circuits include data signal line driver circuits configured to drive data signal lines formed on the display panel,
the data signal line driver circuits and the first data storage portions are mounted on the source boards, and
the timing controllers and the connectors are mounted on the control board.

A sixth aspect of the present invention provides the display device according to the fourth aspect of the present invention, wherein the predetermined times include predetermined time intervals, time of power-on, a time when an artificial operation is made, and time when an environmental change is detected.

A seventh aspect of the present invention provides the display device according to any of the third or fourth aspect of the present invention, wherein,
correction data writing tools write the correction data to the first data storage portions in SPI mode, and
the distinguishing data is 8-bit serial data.

An eighth aspect of the present invention provides the display device according to any of the first through the fourth aspect of the present invention, wherein, the first data storage portions are provided one for each of the timing controllers.

A ninth aspect of the present invention provides the display device according to any of the first through the fourth aspect of the present invention, wherein the first data storage portions are semiconductor memory devices allowing the correction data to be externally rewritten via the connectors.

A tenth aspect of the present invention provides the display device according to the first aspect of the present invention, wherein,
the correction data writing tools are connected to a computer with correction data that are to be written to the respective first data storage portions, and
the computer commands the correction data writing tools to write correction data that are to be written co the first data storage portions, on the basis of the distinguishing information provided by the correction data writing tools.

An eleventh aspect of the present invention provides the display device according to the first aspect of the present invention, wherein,
the correction data writing tools include the correction data that are to be written to the first data storage portions and processors capable of identifying the first data storage portions electrically connected to the correction data writing tools via the connectors, on the basis of the distinguishing information, and
correction data writing tools write the correction data that are to be written, to the first data storage portions connected to the correction data writing tools, on the basis of the distinguishing information provided.

### Effect of the Invention

In the first aspect of the present invention, in the display device with the timing controllers which share the control of the display screen, the correction data writing tools are connected to their corresponding connectors, and obtain distinguishing information for identifying the first data storage portions connected to the connectors. Thereafter, on the basis of the obtained distinguishing information, correction data that should be written are written to the first data storage portions. Thus, even if the worker makes a mistake in the connection of the correction data writing tools, correction data for correcting uneven display which occurs on the display panel can be written to the corresponding first data storage portions without error.

In the second aspect of the present invention, each connector includes terminals for outputting a combination of assigned voltage levels. The correction data writing tool connected to the connector identifies the connector connected thereto, on the basis of the combination of voltage levels outputted from the terminals, and writes correction data that should be written, to the first data storage portion via the connector. Thus, even if the worker makes a mistake in the connecting of the correction data writing tools, correction data for correcting uneven display which occurs on the display panel can be written to their corresponding first data storage portions without error.

In the third aspect of the present invention, on the basis of distinguishing data consisting of a plurality of bits and being read from the first data storage portion electrically connected to the connector, the correction data writing tool connected to the connector identifies the connector, and writes correction data to the first data storage portion via the connector. Thus, even if the worker makes a mistake in the connection of the correction data writing tools, a plurality of pieces of correction data for correcting uneven display which occurs on the display panel can be written to the respective first data storage portions without error.

In the fourth aspect of the present invention, trite second data storage portions with the distinguishing data stored therein are accessed at predetermined times, with the result that the stored distinguishing data, each piece of which consists of a plurality of bits, are read and written to the third data storage portions provided in the timing controllers. After the distinguishing data are written to the third data storage portions, the correction data writing tools read the distinguishing data written in the third data storage portions, at predetermined times via the connectors. Then, the first data storage portions electrically connected to the connectors are identified on the basis of the distinguishing data, and the correction data are written to the first data storage portions. Thus, even if the worker makes a mistake in the connection of the correction data writing tools, a plurality of pieces of correction data for correcting uneven display which occurs on the display panel can be written to their corresponding first data storage portions without error.

In the fifth aspect of the present invention, the source boards are provided in of the control board, thereby eliminating the need to remove the first data storage portions, which have stored therein correction data, including the correction data that inherently varies among liquid crystal panels, from the control board, which is to be replaced most frequently when receiving an on-site repair service for the liquid crystal display device. This significantly reduces the burden on the repair worker.

In the sixth aspect of the present invention, the correction data writing tools can read distinguishing data from the third data storage portions via the connectors at optimal times for image correction, including predetermined time intervals, the time of power-on, the time when an artificial operation is made, and the time when an environmental change is detected.

In the seventh aspect of the present invention, the distinguishing data is 8-bit serial data, and therefore, the data writing tools can readily write the correction data to the first data storage portions in SPI mode.

In the eighth aspect of the present invention, the first data storage portions are provided one for each timing controller, and therefore, correction data for correcting uneven display which occurs on the display panel can be reliably written to the first data storage portions connected to the timing controllers.

In the ninth aspect of the present invention, the first data storage portions are semiconductor memory devices allowing the correction data to be externally rewritten via the connectors, and therefore, when necessity arises to change the correction data, it is possible to quickly address the necessity.

In the tenth aspect of the present invention, the correction data writing tools are connected to a computer having stored therein a plurality of pieces of correction data to be written to the first data storage portions. The computer commands the correction data writing tools to write correction data that should be written, to the first data storage portions, on the basis of the distinguishing information. The correction data writing tools write the correction data that should be written, to their corresponding first data storage portions. Thus, even if the worker makes a mistake in the connection of the correction data writing tools, the liquid crystal display device allows correction data to be reliably written to the first data storage portions to which the correction data should be written.

In the eleventh aspect of the present invention, the correction data writing tools have a plurality of pieces of correction data to be written to the first data storage portions and include processors capable of identifying the first data storage portions connected via the connectors, on the basis of the distinguishing information. Thus, even if the worker makes a mistake in the connection of the correction data writing tools, the liquid crystal display device allows correction data to be reliably written to the first data storage portions to which the correction data should be written. Moreover, the computer is dispensable, and therefore, the cost of writing correction data can be reduced.

### BRIEF DESCRIPTION OF THE DRAWINGS

FIG. 1 is a block diagram illustrating the configuration of a liquid crystal display device according to a first embodiment of the present invention.

FIG. 2 provides diagrams illustrating the configuration of a liquid crystal panel of the liquid crystal display device shown in FIG. 1; more specifically, part (A) is a diagram illustrating the arrangement of data signal lines and scanning signal lines formed on the liquid crystal panel, and part (B) is a diagram illustrating a pixel forming portion formed on the liquid crystal panel.

FIG. 3 provides tables showing connector pin assignment used in SPI communications; more specifically, part (A) provides tables showing pin assignment for conventional connectors, and part (B) tables showing pin assignment for connectors used by the liquid crystal display device.

FIG. 4 is a diagram showing a fashion of connecting correction data writing tools for writing correction data to memory devices of the liquid crystal display device shown in FIG. 1.

FIG. 5 is a diagram illustrating another fashion of connecting the correction data writing tools for writing correction data to the memory devices of the liquid crystal display device shown in FIG. 1.

FIG. 6 is a table showing terminal assignment for a connector used in the case where the control of a display screen of the liquid crystal panel is shared by four timing controllers.

FIG. 7 is a table showing terminal assignment for a connector used in the case where the control of the display screen of the liquid crystal panel is shared by eight timing controllers.

FIG. 8 is a block diagram illustrating the configuration of a liquid crystal display device according to a second embodiment of the present invention.

FIG. 9 is a diagram showing a fashion of connecting correction data writing tools for writing correction data to memory devices of the liquid crystal display device shown in FIG. 8.

FIG. 10 is a diagram showing another fashion of connecting the correction data writing tools for writing correction data to the memory devices of the liquid crystal display device shown in FIG. 8.

FIG. 11 is a block diagram illustrating the configuration of a liquid crystal display device according to a third embodiment of the present invention.

FIG. 12 is a diagram, showing a fashion of connecting correction data writing tools for writing correction data to memory devices of the liquid crystal display device shown in FIG. 11.

FIG. 13 is a diagram showing another fashion of connecting the correction data writing tools for writing correction data to the memory devices of the liquid crystal display device shown in FIG. 11.

FIG. 14 is a block diagram illustrating the configuration of a variant of the liquid crystal display device shown in FIG. 11.

### MODES FOR CARRYING OUT THE INVENTION

### 1. First Embodiment

### <1.1 Configuration of the Liquid Crystal Display Device>

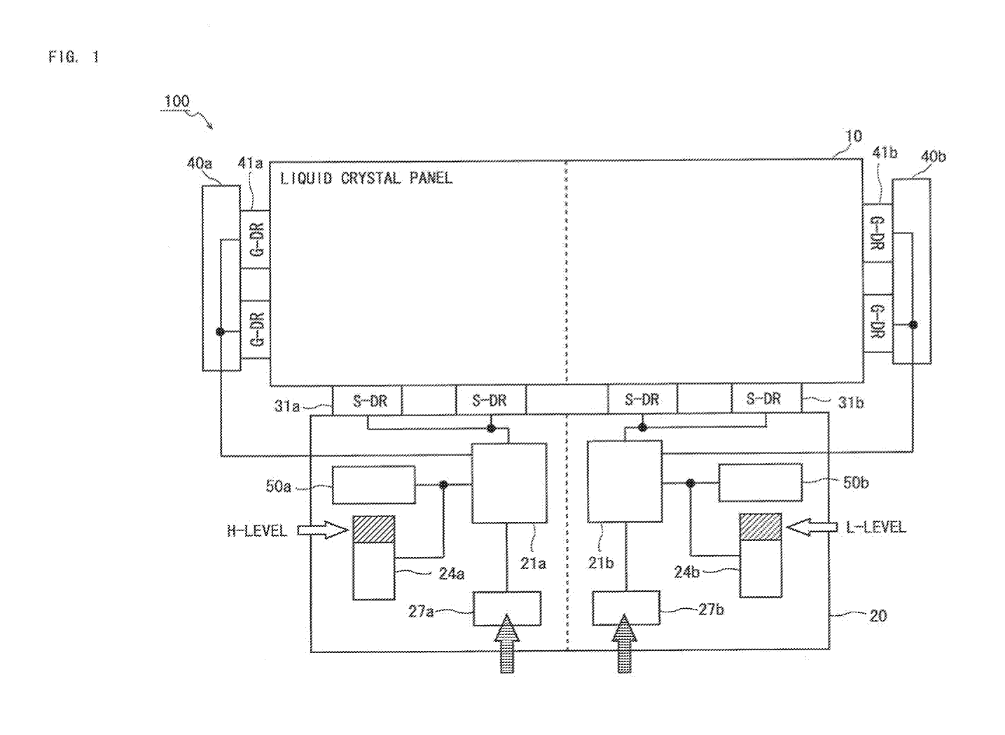

FIG. 1 is a block diagram illustrating the configuration of a liquid crystal display device 100 according to a first embodiment of the present invention. As shown in FIG. 1, the liquid crystal display device 100 includes a liquid crystal panel 10 (also referred to as a “display panel”), two timing controllers 21a and 21b, a plurality of source drivers 31a and 31b (also referred to as “data signal line driver circuits”), a plurality of gate drivers 41a and 41b (also referred to as “scanning signal line driver circuits”), two memory devices 50a and 50b (also referred to as “first data storage portions”) for storing correction data, two connectors 23a and 23b, and two image signal input connectors 27a and 27b. Of these, the timing controller 21a. is electrically connected to the source driver 31a, the gate driver 41a, the memory device 50a, the connector 23a, and the image signal input connector 27a, and the timing controller 21b is electrically connected to the source driver 31b, the gate driver 41b, the memory device 50b, the connector 23b, and the image signal input connector 27b. Of these components, the components other than the liquid crystal panel 10 and the gate drivers 41a and 41b arc mounted on a control board 20 disposed near the liquid crystal panel 10, and the gate drivers 41a and 41b are respectively mounted on two gate boards 40a and 40b so as to be disposed on left and right side surfaces, respectively, of the liquid crystal panel 10. Note that although each of the source driver and the gate driver is mounted in plurality respectively as 31a and 31b and as 41a and 41b, but the number of each type of driver mounted may be one.

In the liquid crystal display device 100, the liquid crystal panel 10 has a display screen divided into left and right areas, which are respectively controlled by the two timing controllers 21a and 21b. As shown in FIG. 1, the timing controller 21a performs control for image display in the left-half area of the display screen, and the timing controller 21b performs control for image display in the right-half area of the display screen.

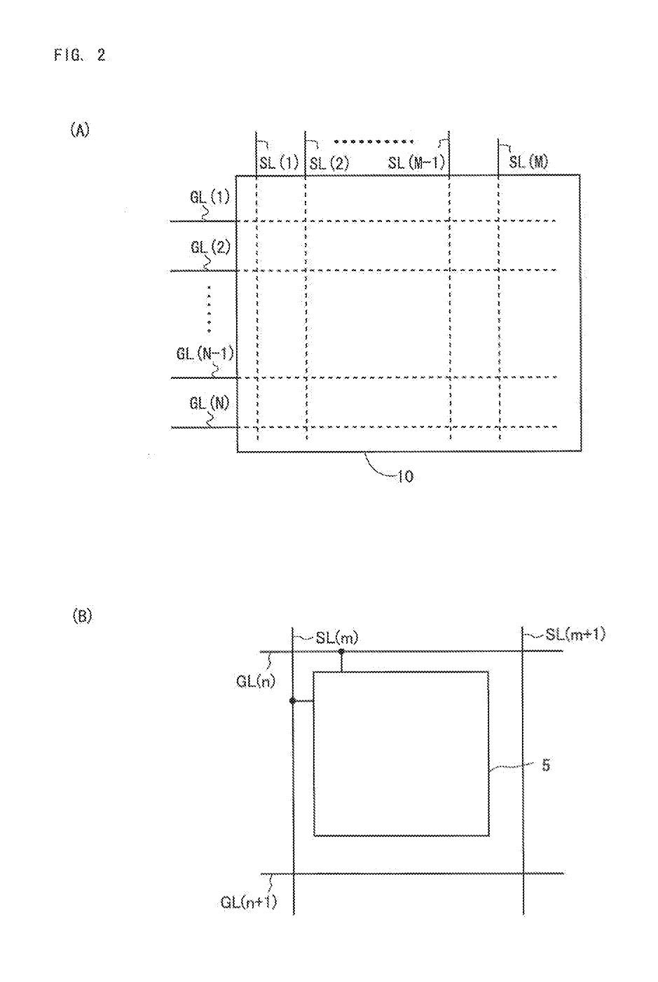

FIG. 2 provides diagrams illustrating the configuration of the liquid crystal panel 10 of the liquid crystal display device 100 shown in FIG. 1; more specifically, FIG. 2(A) is a diagram illustrating the arrangement of data signal lines and scanning signal lines formed on the liquid crystal panel 10, and FIG. 2(B) is a diagram illustrating a pixel forming portion 5 formed on the liquid crystal panel 10. As shown in FIG. 2 (A), the liquid crystal panel 10 has formed thereon a plurality (M) of data signal lines SL(1) to SL(M) and a plurality (N) of scanning signal lines GL(1) to GL(N). For convenience of description, FIG. 2(B) shows only one pixel forming portion 5, but in actuality, there are a plurality (M×N) of pixel forming portions 5 formed corresponding to respective intersections of the data signal lines SL(1) to SL(M) and the scanning signal lines GL(1) to GL(N).

### <1.2 Operation of the Liquid Crystal Display Device>

The operation of the liquid crystal display device 100 will be described with reference to FIG. 1. The liquid crystal display device 100 is externally provided with image signals including image data, which are separately provided as an image signal for image display on the left half of the display screen and an image signal for image display on the right half of the display screen. The image signal for image display on the left half of the display screen is provided to the timing controller 21a via the image signal input connector 27a, and the image signal for image display on the right half of the display screen is provided to the timing controller 21b via the image signal input connector 27b.

On the basis of the inputted image signal, the timing controller 21a generates various timing control signals, such as start pulse signals and clock signals, which are required for driving the source driver 31a and the gate driver 41a, and provides the signals to the source driver 31a and the sate driver 41a, and the timing controller 21a also generates corrected-image data by correcting the image data, and provides the data to the source driver 31a. On the basis of the inputted image signal, the timing controller 21b generates various timing control signals, such as start pulse signals and clock signals, which are required for driving the source driver 31b and the gate driver 41b, and provides the signals to the source driver 31b and the gate driver 41b, and the timing controller 21b also generates corrected-image data by correcting the image data, and provides the data to the source driver 31a.

The gate drivers 41a and 41b mounted on the opposite side surfaces of the liquid crystal panel 10 sequentially activate the N scanning signal lines GL(1) to GL(N) formed on the liquid crystal panel 10. The source driver 31a generates analog signals for display with multiple tones, on the basis of the corrected-image data, and applies the analog signals to the M/2 data signal lines SL(1) to SL(M/2) formed on the left half of the liquid crystal panel 10, at predetermined times, thereby displaying a corrected image on the left half of the display screen. The source driver 31b applies analog signals to the M/2 data signal lines SL (M/2+1) to SL(M) formed on the right half of the liquid crystal panel 10, at predetermined times, thereby displaying a corrected image on the right half of the display screen.

### <1.3 Image Data Correction>

Described next is a case where image data is corrected using correction data. To eliminate uneven display, such as brightness inconsistency and color irregularities, which might occur on the display screen with an image displayed thereon, the liquid crystal display device 100 is provided with the two memory devices 50a and 50b having correction data stored in advance.

When the timing controller 21a is externally provided with an image signal via the image signal input connector 27a, the timing controller 21a reads correction data stored in the memory device 50a, and generates corrected-image data by correcting image data that is to be displayed on the left half of the display screen image data that is to be displayed on the left half of the display screen, using the correction data. Similarly, when the timing controller 21b is externally provided with an image signal via the image signal input connector 27b, the timing controller 21b reads correction data stored in the memory device 50b, and generates corrected-image data by correcting image data that is to be displayed on the right half of the display screen, using the correction data.

The uneven display that occurs on the display screen includes not only a type common among liquid crystal display devices 100 but also type inherently varying from one liquid crystal display device 100 to another, and these types of uneven display vary between the left and right halves of the display screen. Accordingly, there might occur a case where the worker makes an error in the process of writing correction data, with the result that correction data for correcting image data for the left half of the screen is written to the memory device that should store correction data for correcting image data for the right half of the screen, and correction data for correcting image data for the right half of the screen is written to the memory device that should store correction data for correcting image data for the left half of the screen. Described below therefore is a method for properly writing correction data to the respective memory devices 50a and 50b even if the worker makes such an error.

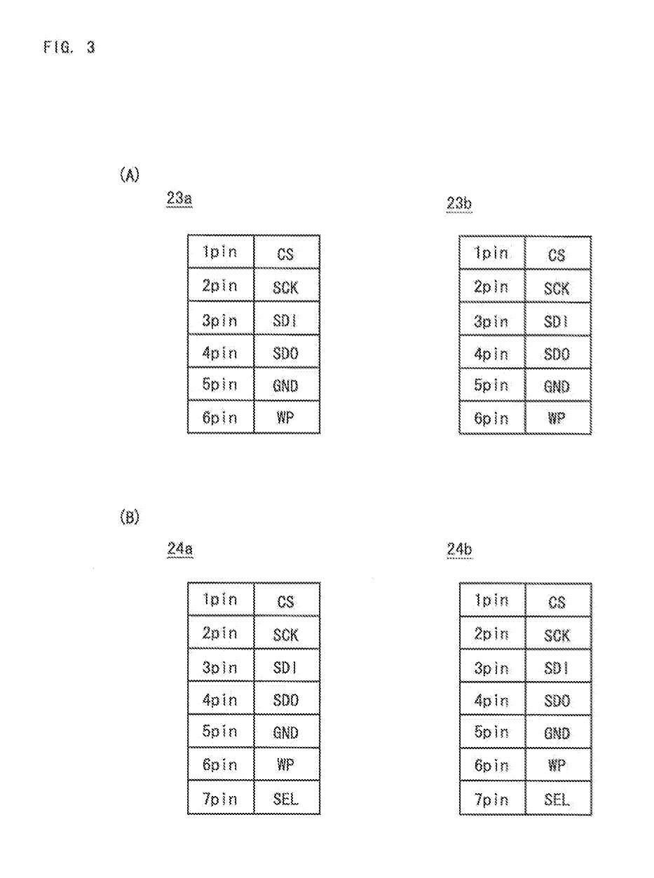

FIG. 3 provides tables showing connector pin assignment used in SPI communications; more specifically, FIG. 3(A) provides tables showing pin assignment for the conventional connectors 23a and 23b, and FIG. 3(B) provides tables showing pin assignment for connectors 24a and 24b used by the liquid crystal display device 100.

The conventional connectors 23a and 23b shown in FIG. 3(A) are 6-pin connectors with the first through fourth pins being terminals for receiving SPI (serial peripheral interface) signals, the fifth pin being a ground terminal, and the sixth pin being a terminal for receiving a write protection disable signal.

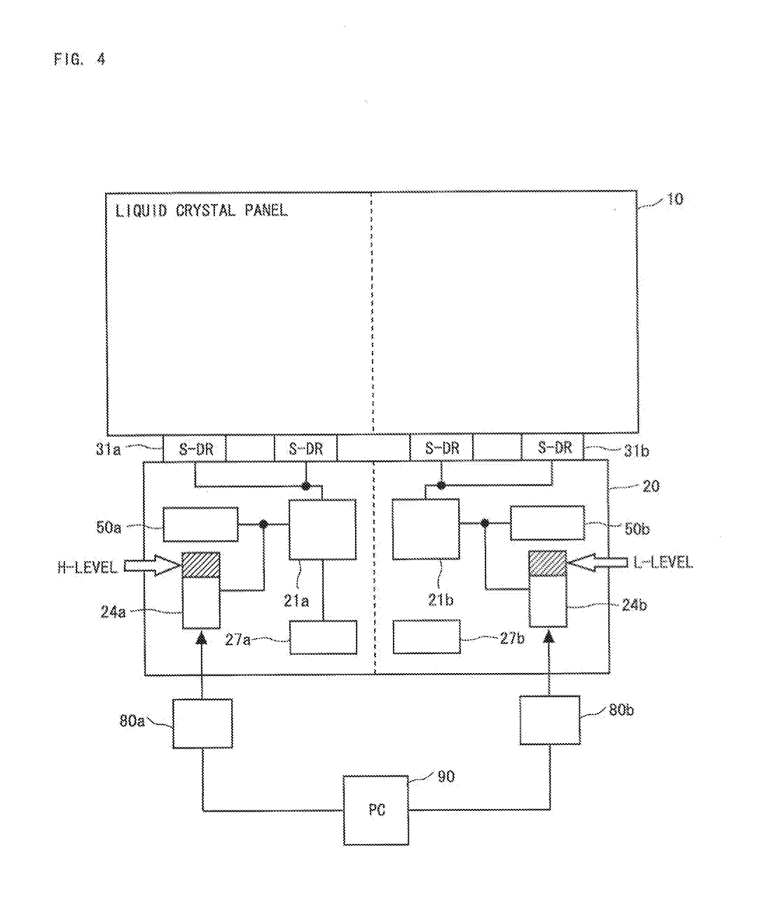

FIG. 4 is a diagram showing a fashion of connecting correction data writing tools 80a and 80b for writing correction data to the memory devices 50a and 50b of the liquid crystal display device 100 shown in FIG. 1. Note that the gate boards 40a and 40b and the gate drivers 41a and 41b are omitted in FIG. 4.

The liquid crystal display device 100 uses the 7-pin connectors 24a and 24b shown in FIG. 3(B). The connectors 24a and 24b have the first through sixth pins for which pin assignment is the same as the connectors 23a and 23b shown in FIG. 3(A), and further have additional seventh pins. The seventh pins are terminals for outputting SEL signals to designate the memory devices 50a and 50b to which correction data is to be written by the correction data writing tools 80a and 80b. The seventh pin of the connector 24a outputs a high-level (H-level) signal from the timing controller 21a as an SEL signal, and the seventh pin of the connector 24b outputs a low-level (L-level) signal derived from the timing controller 21b as an SEE signal. Note that these SEE signals are constantly outputted rather than outputted only when correction data is written to either of the memory devices 50a and 50b. Moreover, these H-level and L-level SEE signals will also be collectively referred to as “distinguishing information”.

The memory devices 50a and 50b are storage media, including rewritable semiconductor memory devices such as flash memory and EEPROM, and have stored therein correction data for correcting uneven display which occurs on the display screen of the liquid crystal panel 10. More specifically, the memory device 50a has stored therein correction data for correcting uneven display which occurs in the left half of the display screen, and the memory device 50b has stored therein correction data for correcting uneven display which occurs in the right half of the display screen. Note that the memory devices 50a and 50b are rewritable semiconductor memory devices, and therefore, when necessity arises to change the correction data stored in the memory devices 50a and 50b, it is possible to quickly address the necessity.

As shown in FIG. 4, the correction data writing tool 80a is connected to the connector 24a to which the tool 80a is supposed to be connected, and the correction data writing tool 80b is connected to the connector 24b to which the tool 80b is supposed to be connected.

In this case, when a PC 90 is provided with an H-level SEL signal from the connector 24a via the correction data writing tool 80a, the PC 90 determines on the basis of the SEL signal that the correction data writing tool 80a is connected to the connector 24a, and provides the correction data writing tool 80a with correction data that is to be written to the memory device 50a. As a result, the correction data writing tool 80a is able to write the correction data to the memory device 50a via the connector 24a.

Similarly, when the PC 90 is provided with an L-level SEL signal from the connector 24b via the correction data writing tool 80b, the PC 90 determines on the basis of the SEL signal that the correction data writing tool 80b is connected to the connector 24b, and provides the correction data writing tool 80b with correction data that is to be written to the memory device 50b. As a result, the correction data writing tool 80b is able to write the correction data to the memory device 50b via the connector 24b.

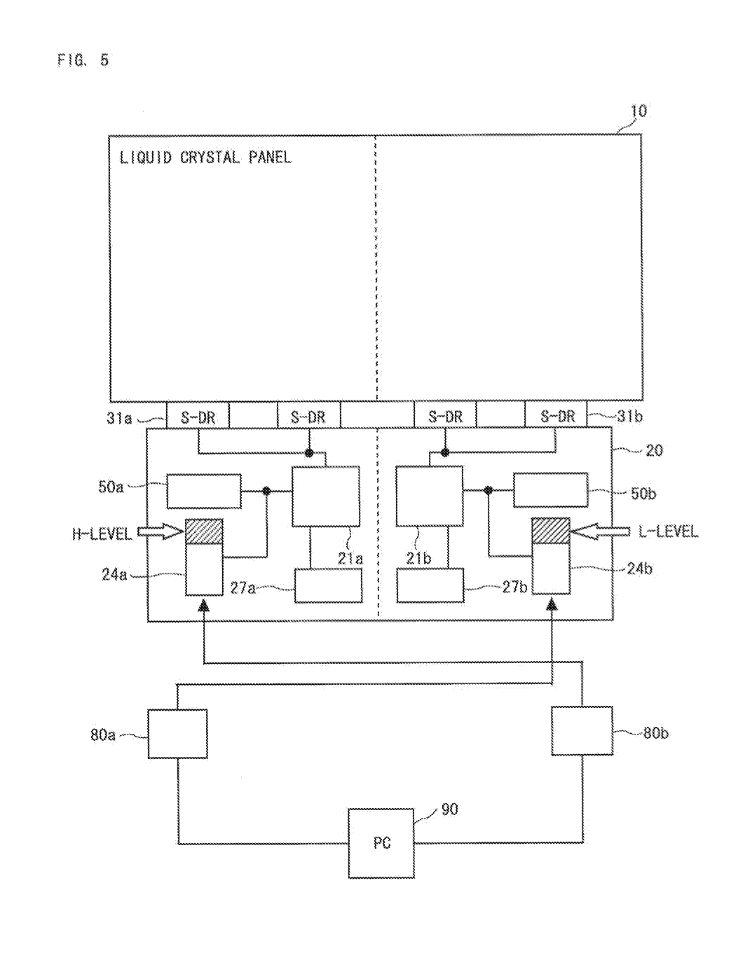

FIG. 5 is a diagram illustrating another fashion of connecting the correction data writing tools 80a and 80b for writing correction data to the memory devices 50a and 50b of the liquid crystal display device 100 shown in FIG. 1. Note that the gate boards 40a and 40b and the gate drivers 41a and 41b are omitted in FIG. 5 as well.

As shown in FIG. 5, due to the worker's error, the correction data writing tool 80a is connected to the connector 24b, rather than the connector 24a to which the tool 80a is supposed to be connected, and the correction data writing tool 80b is connected to the connector 24a, rather than the connector 24b.

In this case, when the PC 90 is provided with an H-level SEL signal from the connector 24a via the correction data writing tool 80b, the PC 90 determines on the basis of the SEL signal that the correction data writing tool 80b is connected to the connector 24a, and provides the correction data writing tool 80b with correction data that is to be written to the memory device 50a. As a result, the correction data writing tool 80b is able to write the correction data to the memory device 50a via the connector 24a.

Similarly, when the PC 90 is provided with an L-level SEL signal from the connector 24b via the correction data writing tool 80a, the PC 90 determines on the basis of the SEE signal that the correction data writing tool 80a is connected to the connector 24b, and provides the correction data writing tool 80a with correction data that is to be written to the memory device 50b. As a result, the correction data writing tool 80a is able to write the correction data to the memory device 50b via the connector 24b.

As described above, although the correction data writing tools 80a and 80b should be connected to the connectors 24a and 24b, respectively, there might be a case where the worker makes a mistake so that the correction data writing tool 80a is connected to the connector 24b, and the correction data writing tool 80b is connected to the connector 24a. Even in such a case, by determining the level of the SEL signals outputted by the connectors 24a and 24b, it is rendered possible that, as in the case of the proper connections, correction data for correcting the left screen, which should be written to the memory device 50a, be written to the memory device 50a, and correction data for correcting the right screen, which should be written to the memory device 50b, be written to the memory device 50b.

It should be noted that in each embodiment of the present invention, the communication mode that is most suitable for writing correction data to the memory devices 50a and 50b is SPI, but this is not limiting, and. other communication modes such as I2C (inter-integrated circuit) may be employed.

### <1.4 Effects>

In the present embodiment, as shown in FIG. 4, the correction data writing tool 80a is connected to the connector 24a, and the correction data writing tool 80b is connected to the connector 24b, but there might also be a case as shown in FIG. 5 where the worker makes a mistake so that the correction data writing tool 80a is connected to the connector 24b, and the correction data writing tool 80b is connected to the connector 24a. Even in such a case, the PC 90 determines whether the SEL signals provided through the seventh pins of the connected connectors 24a and 24b are at H-level or L-level, whereby for each of the correction data writing tools 80a and 80b, it is possible to determine which one of the two connectors 24a and 24b is connected.

Therefore, for example, when the PC 90 determines that the correction data writing tool 80a is connected to the connector 24a, the PC 90 provides the correction data writing tool 80a with correction data that is to be written to the memory device 50a, and when the PC 90 determines that the correction data writing tool 80a is connected to the connector 24b, the PC 90 provides the correction data writing tool 80a with correction data that is to be written to the memory device 50b. Thus, the correction data that is to be written to the memory device 50a is not written to the memory device 50b, nor is the correction data that is to be written to the memory device 50b written to the memory device 50a.

Accordingly, when correction data are written to the respective memory devices 50a and 50b, even if the worker makes an error so that the correction data writing tools are erroneously connected to the connectors to which the tools are not supposed to be connected, the correction data can be written to the respective memory devices 50a and 50b to which the data should be written. As a result, of the image data inputted to the liquid crystal display device 100, the left-screen image data is corrected using correction data being read from the memory device 50a, and the right-screen image data is corrected using correction data being read from the memory device 50b, with the result that the liquid crystal display device 100 is able to display an image free from uneven display.

Furthermore, the liquid crystal display device 100 is simply required to be designed such that the timing controllers 21a and 21b output an SEL signal at H-level voltage to the seventh pin of the connector 24a and an SEP signal at L-level voltage to the seventh pin of the connector 24b. Therefore, the liquid crystal display device 100 is readily designable and highly realizable when compared to liquid crystal display devices according to other embodiments to be described later.

### <1.5 Variants>

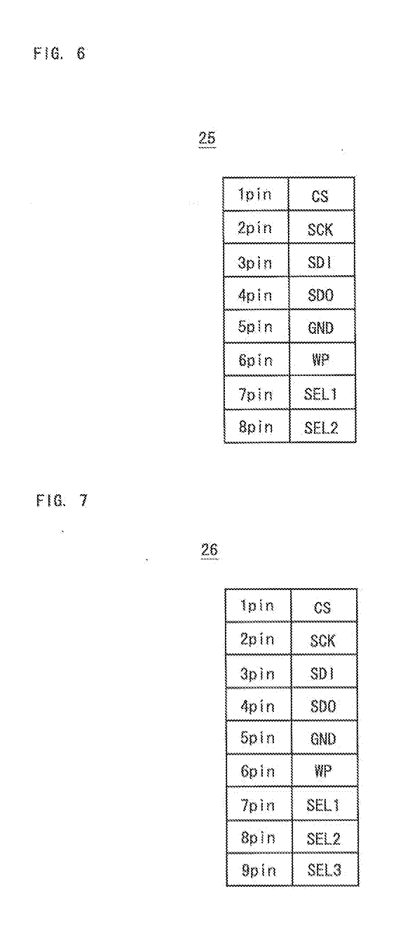

FIG. 6 is a table showing terminal assignment for a connector 25 used in the case where the control of the display screen of the liquid crystal panel 10 is shared by four timing controllers. The connector 25 shown in FIG. 6 is an 8-pin connector which outputs H-level and/or L-level SEL signals from the seventh and eighth pins. Accordingly, the SEL signals from the seventh and eighth pins are outputted in the four combinations “H-level/H-level”, “H-level/L-level”, “L-level/H-level”, and “L-level/L-level”. These combinations will also be collectively referred to as “distinguishing information”.

Therefore, in the case where the control of the display screen of the liquid crystal panel 10 is shared by four timing controllers, the liquid crystal display device requires each timing controller to have one memory device for storing correction data, i.e., four memory devices in total. In the case where the connector 25 is used to write correction data to these four memory devices, and the memory devices respectively support the four combinations, even if the worker erroneously connects a correction data writing tool to a connector to which the tool is not supposed to be connected, correction data can be written to the memory device to which the data should be written.

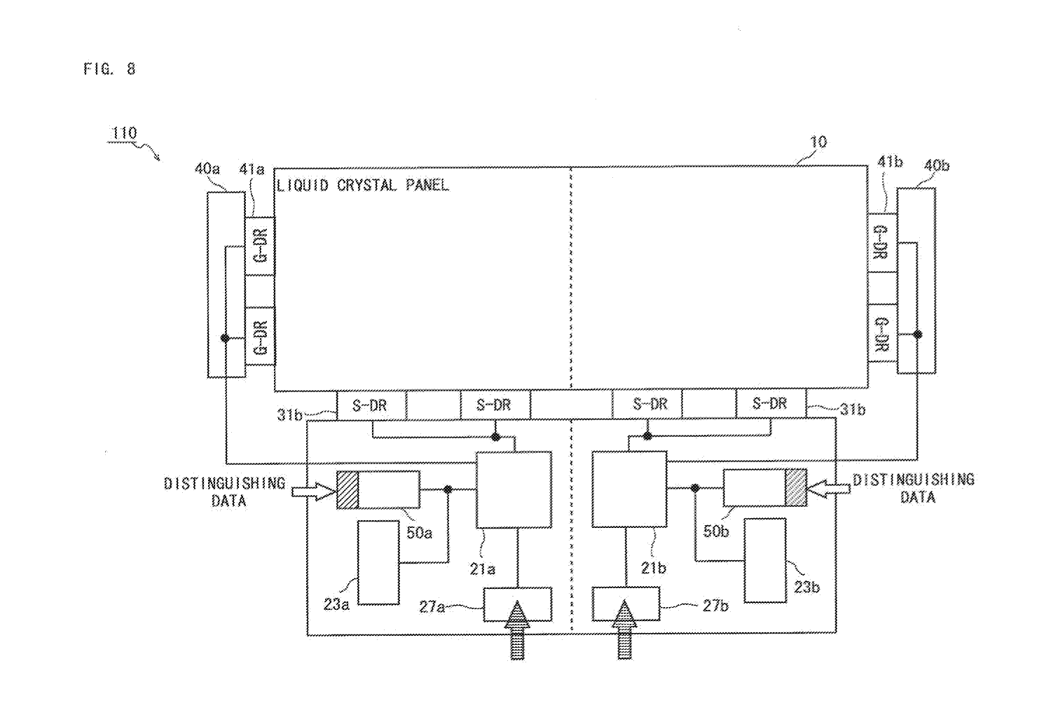

FIG. 7 is a table showing terminal assignment for a connector 26 used in the case where the control of the display screen of the liquid crystal panel 10 is shared by eight timing controllers. The connector 26 shown in FIG. 7 is a 9-pin connector which outputs H-level and/or L-level SEL signals from the seventh through ninth pins. Accordingly, there are eight combinations of SEL signals outputted from the seventh through ninth pins.

Therefore, in the case where the control of the display screen of the liquid crystal panel 10 is shared by eight timing controllers, the liquid crystal display device requires each timing controller to have one memory device for storing correction data, i.e., eight memory devices in total. In the case where the connector 26 is used to write correction data to these eight memory devices, and the memory devices respectively support the four combinations, even if the worker erroneously connects a correction data writing tool to a connector to which the tool is not supposed to be connected, correction data can be written to the memory device to which the data should be written.

The same also applies to the case where the control of the display screen is shared by a higher even number of timing controllers. Moreover, the control of the display screen can be shared by an odd number of timing controllers, though signal processing becomes more complicated when compared to the case where the control is shared by an even number of timing controllers.

### 2. Second Embodiment

FIG. 8 is a block diagram illustrating the configuration of a liquid crystal display device 110 according to a second embodiment of the present invention. As shown in FIG. 8, the components of the liquid crystal display device 110, except the connectors 23a and 23b, are the same as the components of the liquid crystal display device 100 shown in FIG. 1. Accordingly, the components of the liquid crystal display device 110 shown in FIG. 8 that are the same as those of the liquid crystal display device 100 shown in FIG. 1 are denoted by the same reference characters, and any descriptions thereof will be omitted.

The liquid crystal display device 110 uses the 6-pin connectors 23a and 23b shown in FIG. 3(A) as the connectors for writing correction data to the memory devices 50a and 50b, respectively. The connectors 23a and 23b are not provided with any SEL terminals, and therefore, are not capable of outputting H-level or L-level SEP signals even if the correction data writing tools 80a and 80b are connected thereto.

The memory devices 50a and 50b have written therein not only correction data for correcting image data but also data (also referred to as “distinguishing data”) for identifying the memory devices 50a and 50b. The correction data writing tools 80a and 80b are respectively connected to the connectors 23a and 23b, and controlled by the PC 90.

Accordingly, it is possible to write distinguishing data to the memory devices 50a and 50b at a predetermined address, and also rewrite the written distinguishing data.

It should be noted that as in the case of the liquid crystal display device 100 shown in FIG. 1, corrected-image data are generated by correcting image data using correction data written in the memory devices 50a and 50b, and are outputted to the source driver 31a in order to display an image on the display screen of the liquid crystal panel 10, and therefore, any description thereof is omitted.

### <2.1 Method for Writing Correction Data>

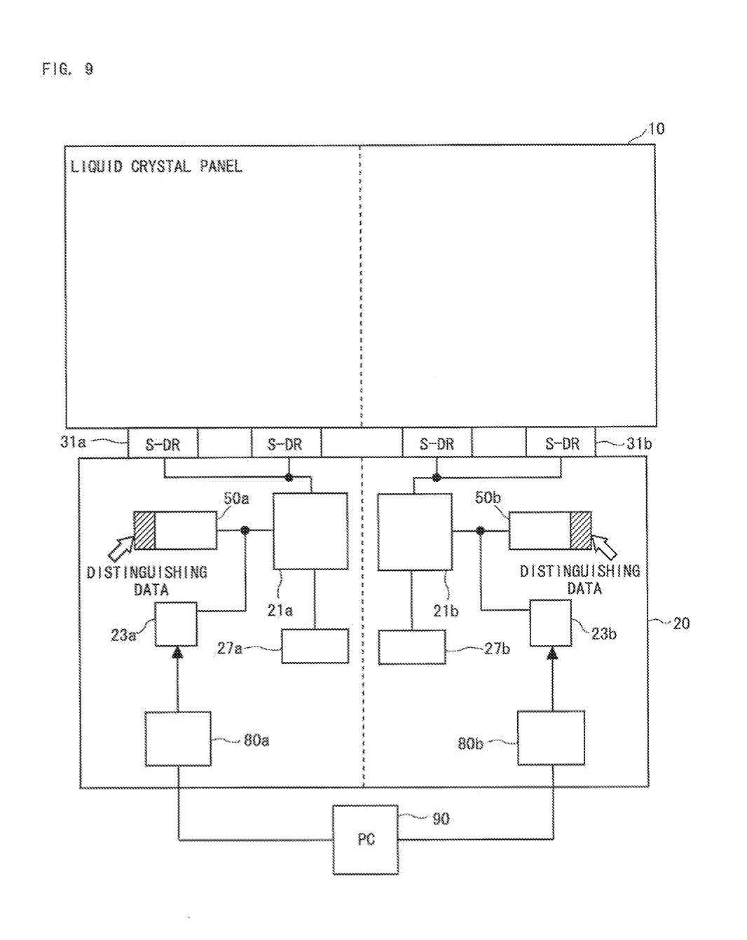

FIG. 9 is a diagram showing a fashion of connecting the correction data writing tools 80a and 80b for writing correction data to the memory devices 50a and 50b of the liquid crystal display device 110 shown in FIG. 8. Distinguishing data are written to the respective memory devices 50a and 50b at a common address. Note that the gate boards 40a and 40b and the gate drivers 41a and 41b are omitted in FIG. 9.

As shown in FIG. 9, the correction data writing tool 80a is connected to the connector 23a to which the tool 80a is supposed to be connected, and the correction data writing tool 80b is connected to the connector 23b to which the tool 80b is supposed to be connected.

In this case, the PC 90 reads distinguishing data written in the memory device 50a, by means of the correction data writing tool 80a connected to the connector 23a. Next, on the basis of the distinguishing data, the PC 90 determines that the correction data writing tool 80a is connected to the connector 23a, and provides the correction data writing tool 80a with correction data that is to be written to the memory device 50a. As a result, the correction data writing tool 80a can write the correction data to the memory device 50a via the connector 23a.

Similarly, the PC 90 reads distinguishing data written in the memory device 50b, by means of the correction data writing tool 80b connected to the connector 23b. Next, on the basis of the distinguishing data, the PC 90 determines that the correction data writing tool 80b is connected to the connector 23b, and provides the correction data writing tool 80b with correction data that is to be written to the memory device 50b. As a result, the correction data writing tool 80b can write the correction data to the memory device 50b via the connector 23b.

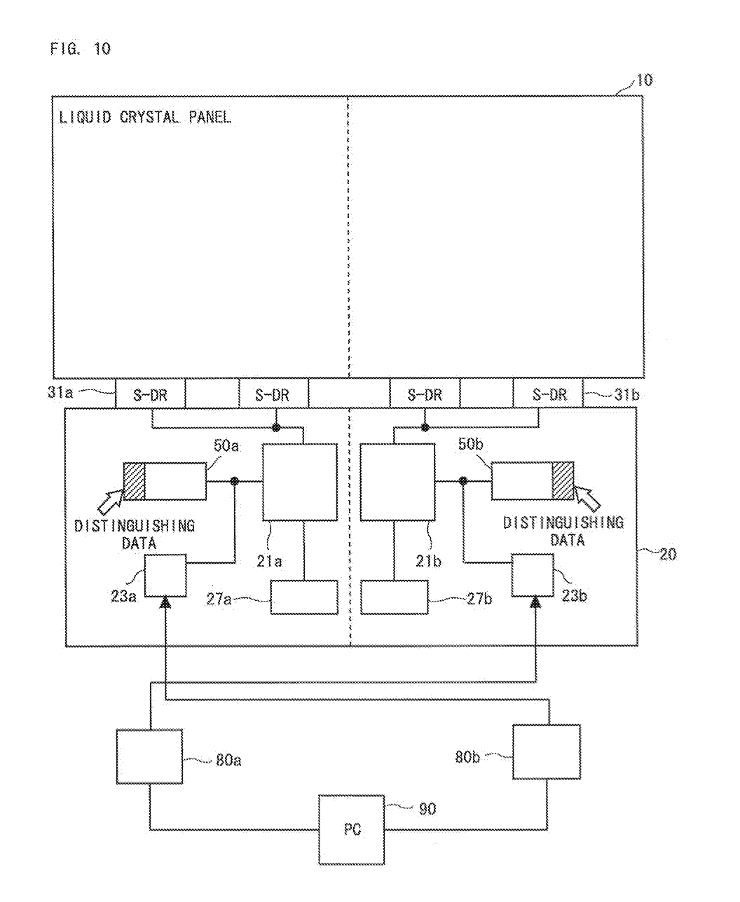

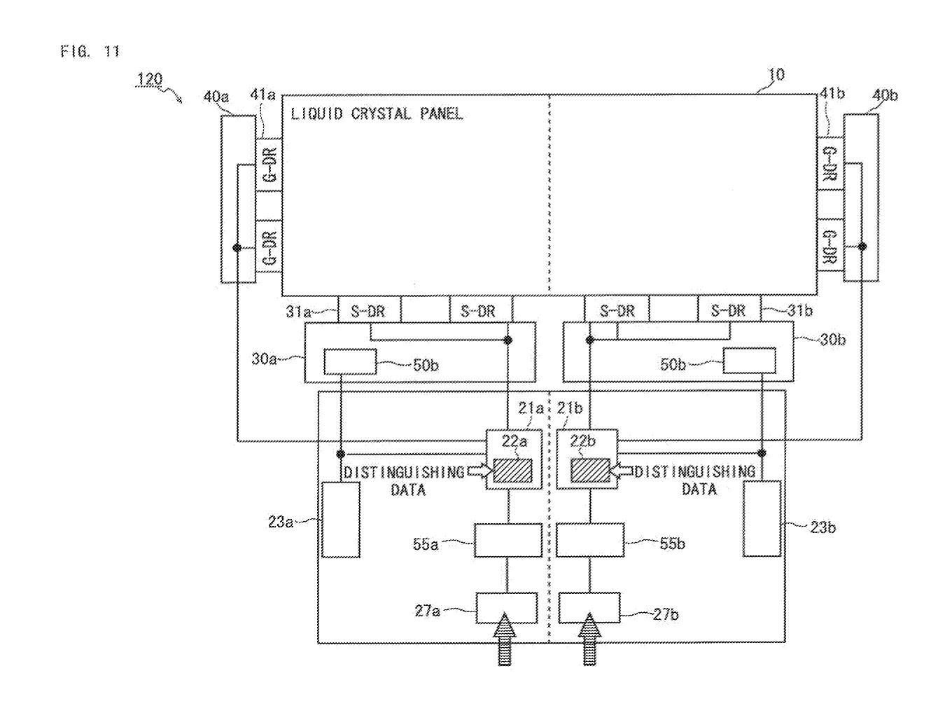

FIG. 10 is a diagram showing another fashion of connecting the correction data writing tools 80a and 80b for writing correction data to the memory devices 50a and 50b of the liquid crystal display device 110 shown in FIG. 8. Note that the gate boards 40a and 40b and the gate drivers 41a and 41b are omitted in FIG. 10 as well.

As shown in FIG. 10, due to the worker's error, the correction data writing tool 80a is connected to the connector 23b, rather than the connector 23a to which the tool 80a is supposed to be connected, and the correction data writing tool 80b is connected to the connector 23a, rather than the connector 23b.

In this case, the PC 90 reads distinguishing data written in the memory device 50a, by means of the correction data writing tool 80b connected to the connector 23a. Next, on the basis of the distinguishing data, the PC 90 determines that the correction data writing tool 80b is connected to the connector 23a, and provides the correction data writing tool 80b with correction data that is to be written to the memory device 50a. As a result, the correction data writing tool 80b can write the correction data to the memory device 50a via the connector 23a.

Similarly, the PC 90 reads distinguishing data written in the memory device 50b, by means of the correction data writing tool 80a connected to the connector 23b. Next, on the basis of the distinguishing data, the PC 90 determines that the correction data writing tool 80a is connected to the connector 23b, and provides the correction data writing tool 80a with correction data that is to be written to the memory device 50b. As a result, the correction data writing tool 80a can write the correction data to the memory device 50b via the connector 23b.

As described above, although the correction data writing tools 80a and 80b should be connected to the connectors 23a and 23b, respectively, there might be a case where the worker makes a mistake so that the correction data writing tool 80a is connected to the connector 23b, and the correction data writing tool 80b is connected to the connector 23a. Even in such a case, on the basis of distinguishing data respectively being read from the memory devices 50a and 50b, correction data for correcting the left screen, which should be written to the memory device 50a, and correction data for correcting the right screen, which should be written to the memory device 50b, can be respectively written to the memory devices 50a and 50b, as in the case of the proper connections.

In the case of the liquid crystal display device 110 also, the correction data writing tools 80a and 80b write correction data to the memory devices 50a and 50b in SPI mode. In SPI mode, typically, data consists of eight bits, and therefore, in the case of the liquid crystal display device 110 also, distinguishing data is preferably represented by 8-bit serial data. Accordingly, to identify the memory devices 50a and 50b, for example, distinguishing data that is to be written to the memory device 50a at a predetermined address is represented by “00000000”, and distinguishing data that is to be written to the memory device 50b at the predetermined address is represented by “00000001”. The PC 90 identifies the connector 23a electrically connected to the memory device 50a and the connector 23b electrically connected to the memory device 50b, on the basis of distinguishing data respectively being read from the memory devices 50a and 50b, with the result that the correction data writing tools respectively connected to the connectors 23a and 23b can be identified. In this manner, in the case where the distinguishing data is represented by 8-bit serial data, up to 256 types of distinguishing data can be identified, and therefore, the control of the display screen can be shared by up to 256 timing controllers. Note that the distinguishing data is not limited to 8-bit serial data, and may be serial data consisting of more bits.

### <2.2 Effects>

In the present embodiment, as in the first embodiment, regardless of whether the correction data writing tools for use in writing correction data to the respective memory devices 50a and 50b are connected to the connector 23a or the connector 23b, the PC 90 can identify the connectors to which the correction data writing tools are connected by reading the distinguishing data written in the memory devices 50a and 50b. Accordingly, by providing proper correction data to the correction data writing tools connected to the connectors 23a and 23b, the PC 90 allows the proper correction data to be written to the respective memory devices 50a and 50b. As a result, of the image data inputted to the liquid crystal display device 110, the left-screen image data is corrected by the correction data being read from the memory device 50a, and the right-screen image data is corrected by the correction data being, read from the memory device 50b, with the result that the liquid crystal display device 110 can display an image free from uneven display.

Furthermore, the liquid crystal display device 110 can use conventional 6-pin connectors 23a and 23b as the connectors 23a and 23b. Accordingly, the liquid crystal display device 110 can be produced at lower cost when compared to liquid crystal display devices which use the high-cost connectors 24a and 24b.

### 3. Third Embodiment

### <3.1 Configuration of the Liquid Crystal Display Device>

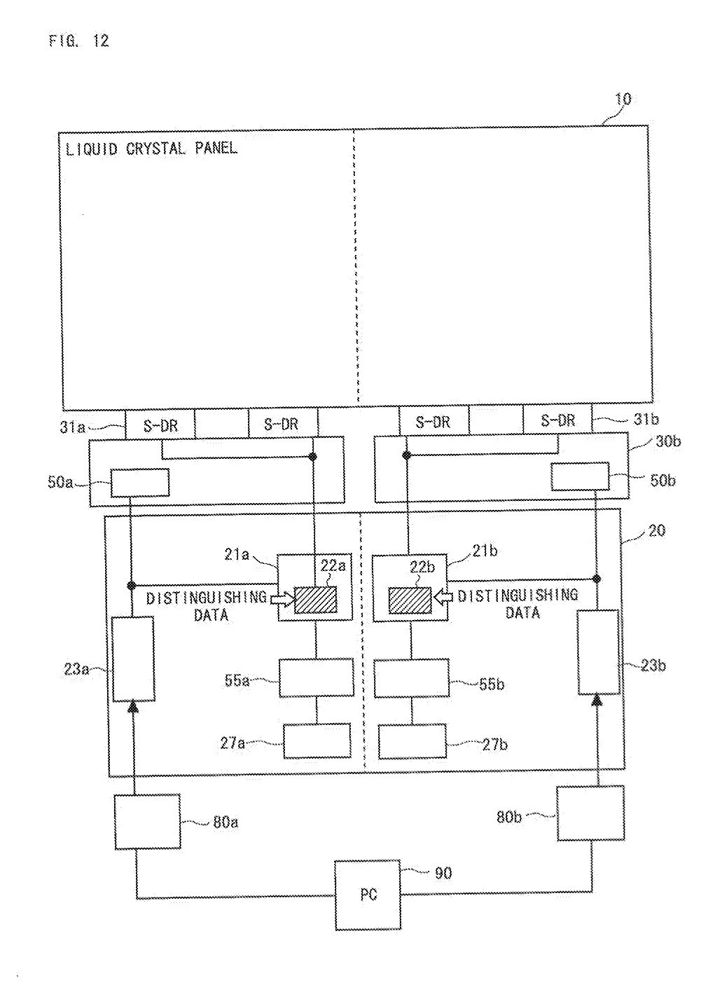

FIG. 11 is a block diagram illustrating the configuration of a liquid crystal display device 120 according to a third embodiment of the present invention. The liquid crystal display device 120 shown in FIG. 11 is configured by additionally providing control data memory devices 55a and 55b (also referred to as “second data storage portions”) to the liquid crystal display device 100 shown in FIG. 1. Moreover, the connectors 23a and 23b are 6-pin connectors as shown in FIG. 3(A). Therefore, the components of the liquid crystal display device 120 shown in FIG. 11 that are the same as the components of the liquid crystal display device 100 shown in FIG. 1 are denoted by the same reference characters, and any descriptions thereof will be omitted.

In the case of the liquid crystal display device 120, as in the case of the liquid crystal display device 100 shown in FIG. 1, corrected-image data are generated by correcting image data using correction data written in the memory devices 50a and 50b, and are outputted to the source drivers 31a and 31b, with the result that the liquid crystal panel 10 displays an image on the display screen, and therefore, any description thereof will be omitted.

In the case of the liquid crystal display device 120, unlike in the first and second embodiments, not only the control board 20 and the gate boards 40a and 40b but also two source boards 30a and 30b connected to the liquid crystal panel 10 by pressure bonding are disposed, as shown in FIG. 11. The source board 30a has the source driver 31a and the memory device 50a mounted thereon, and the source board 30b has the source driver 31b and the memory device 50b mounted thereon.

In this manner, providing the source boards 30a and 30b independently of the control board 20 eliminates the need to remove the memory devices 50a and 50b, which have stored therein correction data, including the correction data that inherently varies among liquid crystal panels 10, from the control board 20, which is to be replaced most frequently when receiving an on-site repair service for the liquid crystal display device 120. This eliminates the need to perform tasks as needed when the repair worker replaces the control board 20, such as the task of moving the correction data stored in the memory devices 50a and 50b on the control board 20 that is to be replaced to memory devices 50a and 50b on a new control board 20, and the task of removing only the memory devices 50a and 50b from the control board 20 that is to be replaced and attaching the memory devices 50a and 50b to a new control board 20. These tasks are a significant burden on the repair worker at the time of on-site repair service for the liquid crystal display device, and therefore, if the need for these tasks is eliminated, the burden on the repair worker is significantly reduced.

The liquid crystal display device 120 is provided. with the two control data memory devices 55a and 55b, in addition to the two memory devices 50a and 50b to which uneven display correction data are to be written. The control data memory device 55a is electrically connected to the image signal input connector 27a and the timing controller 21a, and the control data memory device 55b is electrically connected to the image signal input connector 27b and the timing controller 21b. The control data memory devices 55a and 55b have distinguishing data for identifying the memory devices 50a and 50b externally written thereto via the image signal input connectors 27a and 27b, respectively, along with parameters for the processing of data required for various types of correction, such as digital gamma correction and overshoot drive, excluding data for correcting uneven display, as well as data required for controlling the operation of the timing controllers 21a and 21b, image signals, etc.

The memory device 50a and the timing controller 21a are electrically connected by a data bus formed differently from a data bus electrically connecting the control data memory device 55a and the timing controller 21a. Therefore, even if the correction data writing tool 80a is connected to the connector 23a, the correction data writing tool 80a cannot directly read distinguishing data written in the control data memory device 55a. Likewise, even if the correction data writing tool 80b is connected to the connector 23b, the correction data writing tool 80b cannot directly read distinguishing data written in the control data memory device 55b.

Furthermore, in the process of producing the liquid crystal display device, the tasks performed by the worker on the source boards 30a and 30b include only simple tasks of mounting components and performing conductivity tests and do not include any complicated task such as writing data to the memory devices 50a and 50b. If the step of writing data is added to such a production process, the worker's error might be triggered more easily or there might be an increase in production cost, and therefore, it is not preferable to add a new task.

The time at which the correction data writing tools 80a and 80b respectively read distinguishing data written in registers 22a and 22b is after the timing controller 21a reads distinguishing data written in the control data memory device 55a and writes the data to the register 22a, and the timing controller 21b reads distinguishing data written in the control data memory device 55b and writes the data to the register 22b. Accordingly, as will be described later, the correction data writing tool 80a connected to the connector 23a is able to read distinguishing data written in the register 22a of the timing controller 21a before writing correction data to the memory device 50a. The correction data writing tool 80b connected to the connector 23b is able to read distinguishing data written in the register 22b of the timing controller 21b. Note that the registers 22a and 22b will also be referred to as “third data storage portions”.

Described next is the reason why the memory device 50a to which correction data is written and the control data memory device 55a to which data other than correction data is written are electrically connected to different data buses. In some cases, the timing controller 21a accesses the control data memory device 55a in order to regularly read data written in the control data memory device 55a. In such a case, if the control data memory device 55a is mounted on the same source board 30a as the memory device 50a and electrically connected to the same data bus, EMI (electromagnetic interference) might become worse as a result of the timing controller 21a accessing the control data memory device 55a. Therefore, the control data memory device 55a is preferably connected to a data bus line different from the data bus line to which the memory device 50a is electrically connected.

Furthermore, in the case of the control data memory device 55a, unlike in the case of the memory device 50a, data common among liquid crystal display devices 120 is written, and therefore, replacing the control data memory device 55a along with the control board 20 does not cause a significant burden on the repair worker at an onsite repair service. Therefore, the control data memory device 55a is mounted on the control board 20, rather than on the source board 30a. For the same reason as the foregoing, the memory device 50b to which correction data is written and the control data memory device 55b to which data other than correction data is written are electrically connected to different data buses.

When the timing controller 21a accesses the control data memory device 55a, the timing controller 21a also reads distinguishing data from the control data memory device 55a, and writes the distinguishing data to the register 22a thereof. Similarly, when the timing controller 21b accesses the control data memory device 55b, the timing controller 21b also reads distinguishing data from the control data memory device 55b, and writes the distinguishing data to the register 22b thereof. Note that the timing controller 21a may access the control data memory device 55a at predetermined time intervals or only once at the time of power-on, or the access may be triggered by external factors. In this case, examples of the external factors include human commands made by operating a switch or a remote controller, and information from a sensor having detected a change of the environment such as ambient temperature. As a result, distinguishing data can be read at an optimal time for image correction.

### <3.2 Method for Writing Correction Data>

FIG. 12 is a diagram showing a fashion of connecting the correction data writing tools 80a and 80b for writing correction data to the memory devices 50a and 50b of the liquid crystal display device 120 shown in FIG. 11. Note that the gate boards 40a and 40b and the gate drivers 41a and 41b are omitted in FIG. 12.

As shown in FIG. 12, the correction data writing tool 80a is connected to the connector 23a to which the tool 80a is supposed to be connected, and the correction data writing tool 80b is connected to the connector 23b to which the tool 80b is supposed to be connected.

In this case, the PC 90 reads distinguishing data written in the register 22a of the timing controller 21a, by means of the correction data writing tool 80a connected to the connector 23a. Next, on the basis of the distinguishing data, the PC 90 determines that the correction data writing tool 80a is connected to the connector 23a, and provides the correction data writing tool 80a with correction data that is to be written to the memory device 50a. As a result, the correction data writing tool 80a can write the correction data to the memory device 50a via the connector 23a.

Similarly, the PC 90 reads distinguishing data written in the register 22a of the timing controller 21a, by means of the correction data writing tool 80b connected to the connector 23b. Next, on the basis of the distinguishing data, the PC 90 determines that the correction data writing tool 80b is connected to the connector 23b, and provides the correction data writing tool 80b with correction data that is to be written to the memory device 50b. As a result, the correction data writing tool 80b can write the correction data to the memory device 50b via the connector 23b.

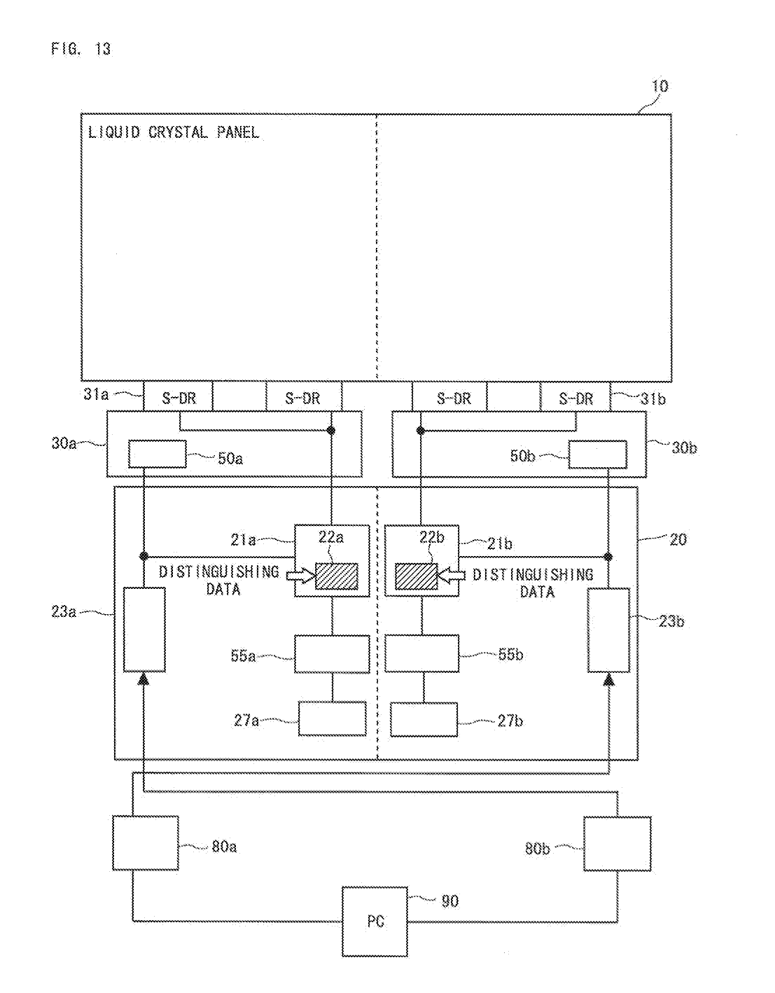

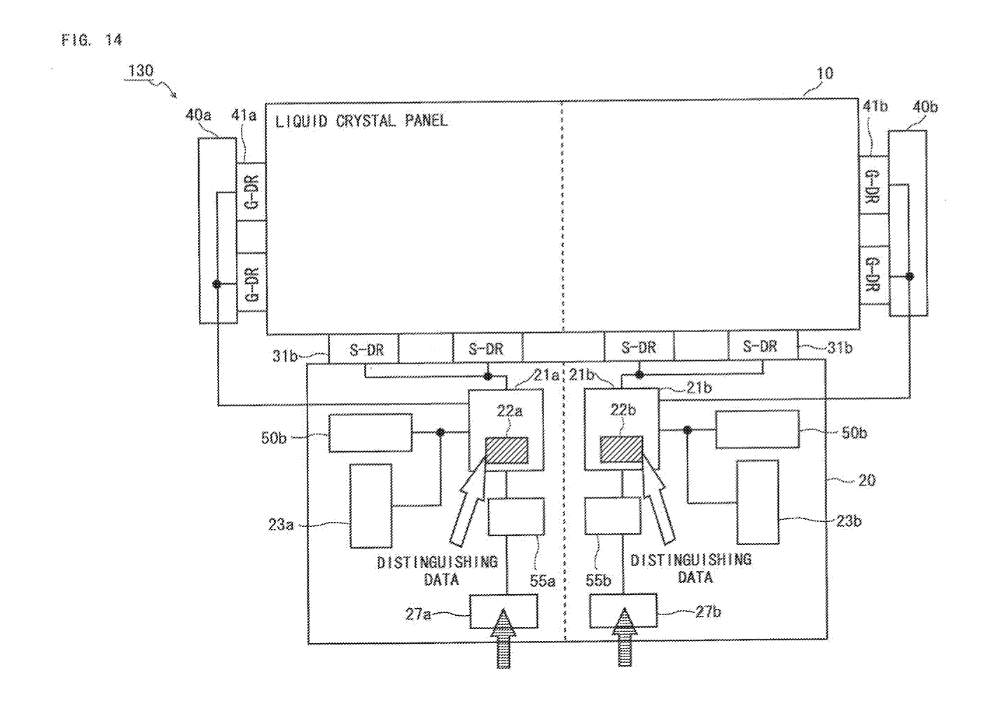

FIG. 13 is a diagram showing another fashion of connecting the correction data writing tools 80a and 80b for writing correction data to the memory devices 50a and 50b of the liquid crystal display device 120 shown in FIG. 11. Note that the gate boards 40a and 40b and the gate drivers 41a and 41b are omitted in FIG. 13.

As shown in FIG. 13, due to the worker's error, the correction data writing tool 80a is connected to the connector 23b rather than the connector 23a to which the tool 80a is supposed to be connected, and the correction data writing tool 80b is connected to the connector 23a rather than the connector 23b.

In this case, the PC 90 reads distinguishing data written in the register 22a of the timing controller 21a, by means of the correction data writing tool 80b connected to the connector 23a. Next, on the basis of the distinguishing data, the PC 90 determines that the correction data writing tool 80b is connected to the connector 23a, and provides the correction data writing tool 80b with correction data that is to be written to the memory device 50a. As a result, the correction data writing tool 80b can write the correction data to the memory device 50a via the connector 23a.

Similarly, the PC 90 reads distinguishing data written in the register 22b of the timing controller 21b, by means of the correction data writing tool 80a connected to the connector 23b. Next, on the basis of the distinguishing data, the PC 90 determines that the correction data writing tool 80a is connected to the connector 23b, and provides the correction data writing tool 80a with correction data that is to be written to the memory device 50b. As a result, the correction data writing tool 80a can write the correction data to the memory device 50b via the connector 23b.

As described above, although the correction data writing tool 80a should be connected to the connector 23a, and the correction data writing tool 80b should be connected to the connector 23b, there might be a case where the worker makes a mistake so that the correction data writing tool 80a is connected to the connector 23b, and the correction data writing tool 80b is connected to the connector 23a. Even in such a case, on the basis of distinguishing data respectively being read from the registers 22a and 22b of the timing controllers 21a and 21b, correction data for correcting the left screen, which should be written to the memory device 50a, and correction data for correcting the right screen, which should be written to the memory device 50b, can respectively be written to the memory devices 50a and 50b, as in the case of the proper connections.

As in the case of the liquid crystal display device 110 described in the second embodiment, the liquid crystal display device 120 writes correction data to the memory devices 50a and 50b in SPI mode. In SPI mode, typically, data consists of eight bits, and therefore, distinguishing data is preferably represented by 8-bit serial data. In this case, as described in the second embodiment, the control of the display screen is shared by up to 256 timing controllers, and the timing controllers correct image data on the basis of correction data written in the respective memory devices provided corresponding thereto. Note that the distinguishing data is not limited to 8-bit serial data, and may be serial data consisting of more bits.

### <3.3 Effects>

In the present embodiment, in the first embodiment, regardless of whether the correction data writing tools for use in writing correction data to the respective memory devices 50a and 50b are connected to the connector 23a or 23b, the PC 90 can identify the connectors to which the correction data writing tools are connected, by reading distinguishing data written in the registers 22a and 22b of the timing controllers 21a and 21b. Accordingly, by providing proper correction data to the respective correction data writing tools connected to the connectors 23a and 23b, the proper correction data can be written to the memory devices 50a and 50b. Therefore, of the image data inputted to the liquid crystal display device 120, the left-screen image data is corrected by the correction data being read from the memory device 50a, and the righty-screen image data can be corrected by the correction data being read from the memory device 50b, with the result that the liquid crystal display device 120 can display an image free from uneven display.

### <3.4 Variant>

FIG. 14 is a block diagram illustrating the configuration of a liquid crystal display device according to a variant of the present embodiment. As shown in FIG. 14, the components of the liquid crystal display device 130 are the same as the components of the liquid crystal display device 120 shown in FIG. 11, except that the source boards 30a and 30b are not included. Therefore, the components of the liquid crystal display device 130 are denoted by the same reference characters as those assigned to the corresponding components of the liquid crystal display device 120, and any descriptions thereof will be omitted.

As shown in FIG. 14, the liquid crystal display device 130 is not provided with the source boards, and therefore, the source drivers 31a and 31b and the memory devices 50a and 50b are mounted on the control board 20. Thus, the production cost of the liquid crystal display device 130 can be reduced.

### <4. Variants Common Among the Embodiments>

In the above embodiments and variant, each timing controller has been described as being provided with one memory device for storing correction data. However, one memory device may be provided to a plurality of timing controllers. For example, in a liquid crystal display device controlled by four timing controllers, the timing controllers may be divided into two groups of two, each group being provided with one memory device. That is, two timing controllers may write respective correction data to one memory device shared therebetween, and also may read the written correction data from that memory device.

Furthermore, in the above embodiments and variant, the PC 90 has been described as determining the level of the SEL signals, and writing correction data to the memory devices to which the data are supposed to be written, in accordance with the determination results. However, the correction data writing tools 80a and 80b may be configured to include processors and memory devices for storing correction data, determine the level of the SEL signals by means of the respective processors, and write correction data to the memory devices 50a and 50b in accordance with the determination results. In this case, the PC 90 is dispensable, and therefore, the cost of writing correction data can be reduced.

### INDUSTRIAL APPLICABILITY

The present invention can be applied to display devices allowing proper writing of correction data for correcting uneven display which occurs due to the worker's

### DESCRIPTION OF THE REFERENCE CHARACTERS

10 liquid crystal panel (display panel)

20 control board

21a, 21b timing controller

22a, 22b register (third data storage portion)

23a, 23b connector

24a, 24b connector

27a, 27b image signal input connector

30a, 30b source board

31 source driver (data signal line driver circuit)

50a,50b memory device (first data storage portion)

55a,55b control data memory (second data storage portion)

80a, 80b correction data writing tool

90 PC (personal computer)

110 to 130 liquid crystal display device

1. A display device comprising:
a display panel;
a plurality of driver circuits configured to drive the display panel;
a plurality of timing controllers configured to generate image data and timing control signals for controlling the driver circuits, on the basis of an externally provided image signal, and provide the image data and the timing control signals to the driver circuits, whereby the control of a display screen of the display panel is shared by the timing controllers;
a plurality of first data storage portions configured to store correction data for use in correcting the image data to eliminate uneven display occurring at the time of image display on the display panel, the first data storage portions being connected to the timing controllers; and
a plurality of connectors electrically connected to the first data storage portions and the timing controllers, wherein,
the connectors are connected to a plurality of correction data writing tools capable of writing the correction data, whereby the correction data writing tools obtain distinguishing information for identifying the first data storage portions, via the connectors, and write the correction data that are to be written, to the respective first data storage portions on the basis of the distinguishing information, and
the timing controllers correct the image data using the correction data being read from the first data storage portions.

2. The display device according to claim 1, wherein,
the distinguishing information is a combination of different voltage levels assigned to the respective first data storage portions,
the connectors include terminals for outputting the combination of assigned voltage levels, and
the correction data writing tools connected to the connectors identify the connected connectors on the basis of the combination of voltage levels outputted from the terminals, and write the correction data to the first data storage portions via the connectors.

3. The display device according to claim 1, wherein,
the distinguishing information is distinguishing data consisting of a plurality of bits written in the first data storage portions, and
the correction data writing tools connected to the connectors identify the connectors electrically connected to the first data storage portions, on the basis of the distinguishing data being read from the first data storage portions, and write the correction data to the first data storage portions via the connectors.

4. The display device according to claim 1, wherein,
the distinguishing information is distinguishing data consisting of a plurality of bits written in the first data storage portions,
the display device further includes a plurality of second data storage portions configured to store the distinguishing data externally provided along with the image signal, the second data storage portions being electrically connected to the timing controllers,
the timing controllers include third data storage portions, access the second data storage portions at predetermined times to read the image signal including the stored distinguishing data, and write at least the distinguishing data to the third data storage portions, and
when the distinguishing data is written to the third data storage portion, the correction data writing tool reads the distinguishing data written in the third data storage portion of the timing controller via the connector, identifies the first data storage portion electrically connected to the connector on the basis of the distinguishing data, and writes the correction data to the first data storage portion via the connector.

5. The display device according to claim 4, further comprising a control board and source boards provided close to the display panel and having components of the display device mounted thereon, wherein,
the driver circuits include data signal line driver circuits configured to drive data signal lines formed on the display panel,
the data signal line driver circuits and the first data storage portions are mounted on the source boards, and
the timing controllers and the connectors are mounted on the control board.

6. The display device according to claim 4, wherein the predetermined times include predetermined time intervals, time of power-on, a time when an artificial operation is made, and a time when an environmental change is detected.

7. The display device according to claim 3, wherein,
the correction data writing tools write the correction data to the first data storage portions in SPI mode, and
the distinguishing data is 8-bit serial data.

8. The display device according to claim 1, Wherein the first data storage portions are provided one for each of the timing controllers.

9. The display device according to claim 1, wherein the first data storage portions are semiconductor memory devices allowing the correction data to be externally rewritten via the connectors.

10. The display device according to claim 1, wherein,
the correction data writing tools are connected to a computer with correction data that are to be written to the respective first data storage portions, and
the computer commands the correction data writing tools to write correction data that are to be written to the first data storage portions, on the basis of the distinguishing information provided by the correction data writing tools.

11. The display device according to claim 1, wherein,
the correction data writing tools include the correction data that are to be written to the first data storage portions and processors capable of identifying the first data storage portions electrically connected to the correction data writing tools via the connectors, on the basis of the distinguishing information, and
the correction data writing tools write the correction data that are to be written, to the first data storage portions connected to the correction data writing tools, on the basis of the distinguishing information provided.
